(19) United States
(12) Patent Application Publication
(10) Pub. No.: US 2016/0342248 A1
(43) Pub. Date: Nov. 24, 2016

(54) DISPLAY PANEL HAVING TOUCH FUNCTION AND THE TOUCH DETECTION METHOD THEREOF

(71) Applicant: SHENZHEN CHINA STAR OPTOELECTRONICS TECHNOLOGY CO. LTD., Shenzhen City, Guangdong (CN)

(72) Inventor: Chengliang YE, Shenzhen, Guangdong (CN)

(73) Assignee: Shenzhen China Star Optoelectronics Technology Co. Ltd., Shenzhen, Guangdong (CN)

(21) Appl. No.: 14/433,619

(22) PCT Filed: Jan. 9, 2015
(86) PCT No.: PCT/CN2015/070401

§ 371 Date: Apr. 3, 2015

(30) Foreign Application Priority Data
Jan. 5, 2015 (CN) 201510003890.6

(51) Int. Cl. G06F 3/041; G06F 3/044; G09G 3/36

(52) U.S. Cl. CPC G06F 3/0412; G09G 3/3677; G09G 3/3688; G06F 3/0416; G06F 3/044; G09G 2310/027

(57) ABSTRACT

A display panel having touch function and the touch detection method thereof are disclosed. The gate driver performs gate driving operations toward the gate lines in sequence. In addition, a first time gap is configured between two consecutive gate driving operations within the same frame, and a second time gap is configured between two consecutive gate driving operations for two consecutive frames. The touch driver performs the touch driving operations toward the touch electrodes during the first time gap and the second time gap such that the display signals and the touch signals are not overlapped with each other. In this way, the display signals and the touch signals are prevented from being interfered by each other so as to enhance the touch and the display performance.

### BACKGROUND OF THE INVENTION

1. Field of the Invention

The present disclosure relates to liquid crystal display technology, and more particularly to a display panel having touch function and the touch detection method thereof.

2. Discussion of the Related Art

Currently, display devices with touch function have been a new trend, wherein the capacitive touch function is embedded within the in-cell technology, which contributes to the thinner and lighter attributes of display panels. With respect to the in-cell display panels, driving frequency of touch electrodes is higher than that of the scanning driving frequency of the gate line. During the scanning process of the same frame, display signals and touch signals may be overlapped. That is, the display signals and the touch signals may interfere each other, which may affect the touch and display performance of the display panel.

### SUMMARY

According to the present disclosure, a display panel having touch function and the touch detection method thereof for enhancing the touch and display performance is disclosed.

In one aspect, a display panel having touch function includes: a display component, a touch component, and a common electrode, the display component and the touch component share the common electrode, the display component includes a plurality of gate lines arranged along a predetermined direction and a gate driver for driving the gate lines, the gate lines being spaced apart from each other, the touch component includes a plurality of touch electrodes arranged along the predetermined direction and a touch driver for driving the touch electrodes, and the touch electrodes are spaced apart from each other, the gate driver is configured for performing gate driving operations for the gate lines in sequence, a first time gap is configured between two consecutive gate driving operations within one frame, a second time gap is configured between two consecutive gate driving operations for two consecutive frames, the touch driver being configured for performing the touch driving operations toward the touch electrodes during the first time gap and the second time gap in sequence, the display component is configured for performing touch driving operations within the first time gap and the second time gap when a voltage of the common electrode is in a stable state; and the display panel is divided into a plurality of blocks along the predetermined direction, each of the blocks includes a plurality of gate lines and a plurality of touch electrodes, a number of the gate lines within one block is larger than the number of the touch electrodes within the same block, the consecutive gate driving operations and the touch driving operations are performed within different blocks, within each frame, the touch driver is configured for performing the touch driving operations toward the same touch electrode at least twice.

Wherein the number of the gate lines within one block is as twice as many as the number of the touch electrodes, the touch driver is configured for performing the touch driving operations toward the touch electrodes within a first block and a last block during the second time gap, and the touch driver is configured for performing the touch driving operations toward the touch electrodes within other blocks during the first time gap such that the touch driver is configured for performing the touch driving operations toward one touch electrodes twice.

Wherein the display component further includes: a plurality of data lines intersecting with the gate lines and a data driver for driving the data lines, the data lines are spaced apart from each other, and the data lines and the gate lines are insulated from each other, the gate lines and the data lines cooperatively define a plurality of pixel areas in a matrix; TFTs and pixel electrodes arranged within each of the pixel areas, a gate of the TFT being connect to the corresponding gate line, a source of the TFT being connected to the corresponding data line, a drain of the TFT being connected to the pixel electrode, and the data driver is configured for performing grayscale driving operations toward the data lines when the gate driver performs the gate driving operations.

In another aspect, a display panel having touch function includes: a display component and a touch component, the display component includes a plurality of gate lines arranged along a predetermined direction and a gate driver for driving the gate lines, the gate lines being spaced apart from each other, the touch component includes a plurality of touch electrodes arranged along the predetermined direction and a touch driver for driving the touch electrodes, and the touch electrodes are spaced apart from each other, the gate driver is configured for performing gate driving operations for the gate lines in sequence, a first time gap is configured between two consecutive gate driving operations within one frame, a second time gap is configured between two consecutive gate driving operations for two consecutive frames, and the touch driver is configured for performing the touch driving operations toward the touch electrodes during the first time gap and the second time gap in sequence.

Wherein the display panel is divided into a plurality of blocks along the predetermined direction, each of the blocks includes a plurality of gate lines and a plurality of touch electrodes, a number of the gate lines within one block is larger than the number of the touch electrodes within the same block, the consecutive gate driving operations and the touch driving operations are performed within different blocks, within each frame, the touch driver is configured for performing the touch driving operations toward the same touch electrode at least twice.

Wherein the number of the gate lines within one block is as twice as many as the number of the touch electrodes, the touch driver is configured for performing the touch driving operations toward the touch electrodes within a first block and a last block during the second time gap, and the touch driver is configured for performing the touch driving operations toward the touch electrodes within other blocks during the first time gap such that the touch driver is configured for performing the touch driving operations toward one touch electrodes twice.

Wherein the display component further includes: a plurality of data lines intersecting with the gate lines and a data driver for driving the data lines, the data lines are spaced apart from each other, and the data lines and the gate lines are insulated from each other, the gate lines and the data lines cooperatively define a plurality of pixel areas in a matrix; TFTs and pixel electrodes arranged within each of the pixel areas, a gate of the TFT being connect to the corresponding gate line, a source of the TFT being connected to the corresponding data line, a drain of the TFT being connected to the pixel electrode, and the data driver is configured for performing grayscale driving operations toward the data lines when the gate driver performs the gate driving operations.

Wherein the display panel further includes a common electrode, the display component and the touch component share the common electrode, and the display component is configured for performing the touch driving operations within the first time gap and the second time gap when a voltage of the common electrode is in a stable state

In another aspect, a touch detection method for a display panel, the display panel includes a display component and a touch component, the display panel includes a plurality of gate lines arranged along a predetermined direction and a gate driver for driving the gate lines, the gate lines being spaced apart from each other, the touch component includes a plurality of touch electrodes arranged along the predetermined direction and a touch driver for driving the touch electrodes, the method comprising: performing gate driving operations on the gate lines in sequence by the gate driver; configuring a first time gap between two consecutive gate driving operations within the same frame and configuring a second time gap between two consecutive gate driving operations for two consecutive frames; and performing the touch driving operations toward the touch electrodes during the first time gap and the second time gap by the touch driver.

Wherein the display panel is divided into a plurality of blocks along the predetermined direction, each of the blocks includes a plurality of gate lines and a plurality of touch electrodes, a number of the gate lines within one block is larger than the number of the touch electrodes within the same block, the consecutive gate driving operations and the touch driving operations are performed within different blocks, within each frame, the touch driver is configured for performing the touch driving operations toward the same touch electrode at least twice.

Wherein the number of the gate lines within one block is as twice as many as the number of the touch electrodes, the touch driver is configured for performing the touch driving operations toward the touch electrodes within a first block and a last block during the second time gap, and the touch driver is configured for performing the touch driving operations toward the touch electrodes within other blocks during the first time gap such that the touch driver is configured for performing the touch driving operations toward one touch electrodes twice.

Wherein the display component further includes: a plurality of data lines intersecting with the gate lines and a data driver for driving the data lines, the data lines are spaced apart from each other, and the data lines and the gate lines are insulated from each other, the gate lines and the data lines cooperatively define a plurality of pixel areas in a matrix; and TFTs and pixel electrodes arranged within each of the pixel areas, a gate of the TFT being connect to the corresponding gate line, a source of the TFT being connected to the corresponding data line, a drain of the TFT being connected to the pixel electrode, and the data driver is configured for performing grayscale driving operations toward the data lines when the gate driver performs the gate driving operations.

Wherein the display panel further includes a common electrode, the display component and the touch component share the common electrode, and the display component is configured for performing the touch driving operations within the first time gap and the second time gap when a voltage of the common electrode is in a stable state.

In view of the above, a first time gap (t₁) is configured between two consecutive gate driving operations within the same frame, and a second time gap (t₂) is configured between two consecutive gate driving operations for two consecutive frames. The touch driver performs the touch driving operations toward the touch electrodes during the first time gap (t₁) and the second time gap (t₂) such that the display signals and the touch signals are not overlapped with each other. In this way, the display signals and the touch signals are prevented from being interfered by each other so as to enhance the touch and the display performance.

### BRIEF DESCRIPTION OF THE DRAWINGS

FIG. 1 is a schematic view of the display panel in accordance with one embodiment.

FIG. 2 is a schematic view of the display component of FIG. 1.

FIG. 3 is a signal timing diagram of the gate line and the touch electrode in accordance with one embodiment.

FIG. 4 is a schematic view of the display panel in accordance with another embodiment.

FIG. 5 is a flowchart of the touch detection method in accordance with one embodiment.

### DETAILED DESCRIPTION OF THE EMBODIMENTS

Embodiments of the invention will now be described more fully hereinafter with reference to the accompanying drawings, in which embodiments of the invention are shown.

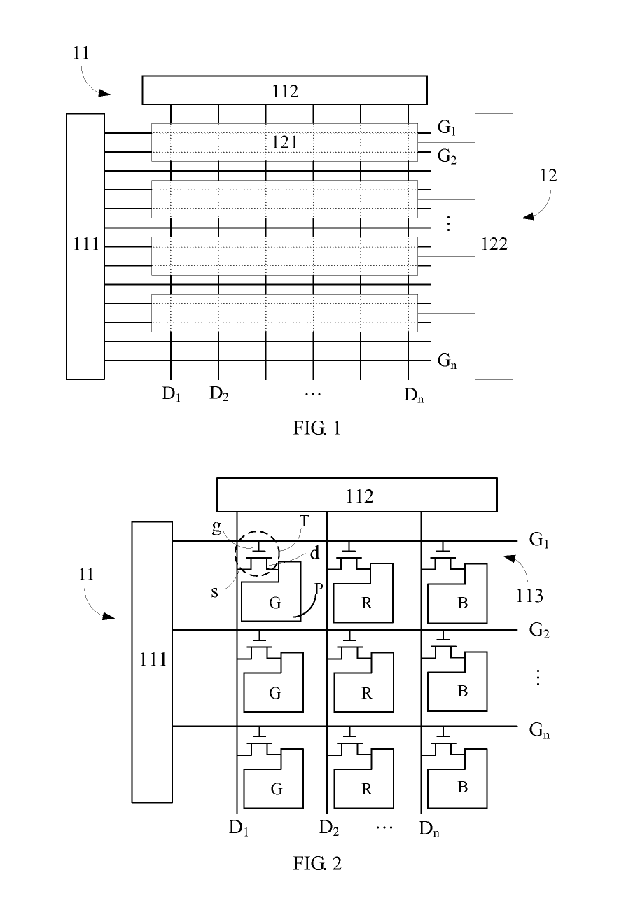

FIG. 1 is a schematic view of the display panel in accordance with one embodiment. As shown, the liquid crystal display panel includes a display component 11 and a touch component 12. The touch component 12 is configured for providing touch function of the display panel. The touch component 12 includes a plurality of touch electrodes 121 arranged along a predetermined direction, and the touch electrodes 121 are spaced apart from each other. The touch component 12 further includes a touch driver 122 for driving the touch electrodes 121. The touch electrodes 121 may be stripe-like.

FIG. 2 is a schematic view of the display component of FIG. 1. As shown, the display component 11 is the liquid crystal display panel without touch function. The display component 11 includes a gate driver 111, a data driver 112, a plurality of gate lines (G₁,G₂, . . . ,Gₙ) arranged along the predetermined direction, and a plurality of data lines (D₁,D₂, . . . ,Dₙ) intersecting with the gate lines (G₁,G₂, . . . ,Gₙ). The gate lines (G₁,G₂, . . . ,Gₙ) are spaced apart from each other. The data lines (D₁,D₂, . . . ,Dₙ) and the gate lines (G₁,G₂, . . . ,Gₙ) are insulated from each other. The gate lines (G₁,G₂, . . . ,Gₙ) and the data lines (D₁,D₂, . . . ,Dₙ) cooperatively define a plurality of pixel areas 113 arranged in a matrix.

Each of the pixel areas 113 includes a thin film transistor (TFT) and a pixel electrode (P). The pixel electrode (P) is arranged opposite to a common electrode 13. The TFT (T) includes a gate (g), a source (s), and a drain (d). The pixel electrode (P) connects to the corresponding drain (d). The gate line connects to the corresponding gate (g). The data line connects to the corresponding source (s). When the TFT (T) is turn on, data driving signals are transmitted to the corresponding pixel electrode (P) via the source (s).

The gate driver 111 is configured to provide the gate driving signals for the gate lines (G₁,G₂, . . . ,Gₙ) in sequence for performing gate driving operations for the gates of the gate lines (G₁,G₂, . . . ,Gₙ) in sequence. In addition, the gate driver 111 turns on the TFT (T) corresponding to each of the gate lines. The data driver 112 is configured to provide grayscale driving signals for the data lines (D₁,D₂, . . . ,Dₙ) so as to perform grayscale driving operations to the data lines (D₁,D₂, . . . ,Dₙ) in sequence. In addition, the data driver 112 applies the grayscale driving signals toward the corresponding pixel electrode (P) via the TFTs (T) that have been turn on. In the embodiment, when the gate driver 111 performs the gate driving operations, the data driver 112 performs the grayscale driving operations for the data lines.

In the embodiment, the same gate line drives a plurality of corresponding pixel areas 113. In addition, the pixel areas 113 respectively shows green (G), red (R), and blue (B) as shown in FIG. 2. When the gate lines transmits the gate driving signals, the TFTs (T) within the pixel areas 113 driven by the same gate line are turn on at the same time. The data lines (D₁,D₂, . . . ,Dₙ) transmit the gray driving signals to the corresponding pixel electrode (P) so as to charge the pixel areas 113 displaying different colors.

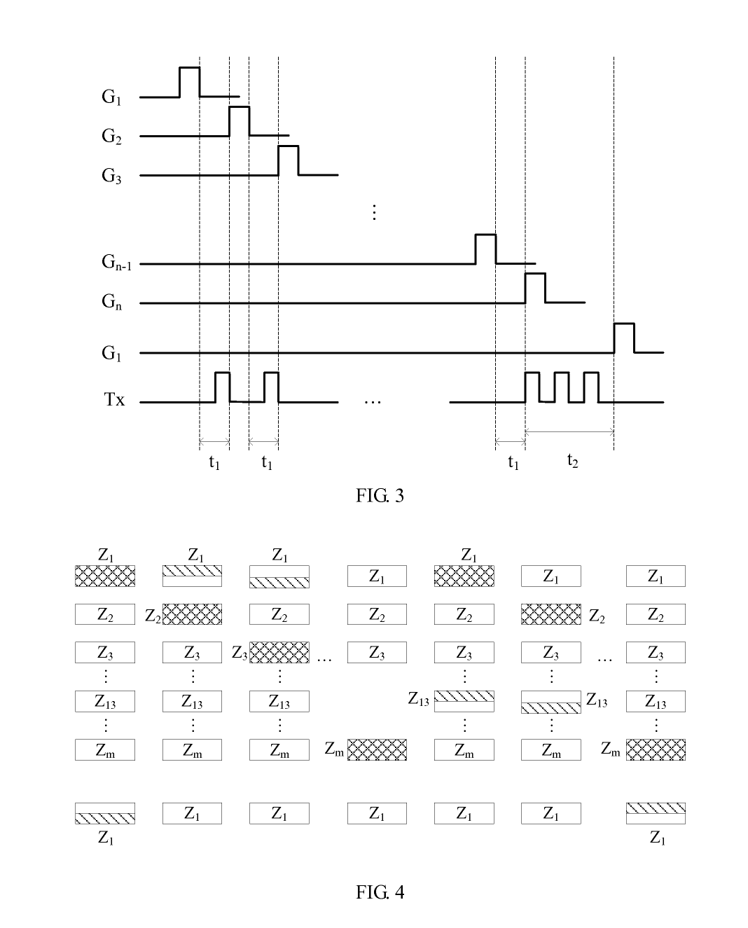

FIG. 3 is a signal timing diagram of the gate line and the touch electrode in accordance with one embodiment. As shown, the touch driver 122 outputs the touch signals (Tx) such that the touch electrode 121 is controlled to perform the touch detection operations in response to the touch signals (Tx). The gate line (G₁˜Gₙ) corresponds to the same frame. The gate line (G₁˜Gₙ) and the gate line G₁ correspond to two consecutive frame. Within the same frame, there is a first time gap (t₁) between two consecutive gate driving operations. With respect to two consecutive gate driving operations for two consecutive frames, such as gate line (G₁) and gate line (Gₙ), there is a second time gap (t₂). The touch driver 122 performs the touch driving operations during the first time gap (t₁) and the second time gap (t₂) in turn such that the gate driving signals and the touch signals are not overlapped with each other. In this way, the signals are not interfered by each other so as to enhance the touch and display performance

FIG. 4 is a schematic view of the display panel in accordance with another embodiment. The touch detection process will be described hereinafter with reference to FIG. 4.

As shown in FIG. 4, the display panel is divided into a plurality of blocks (Z₁,Z₂, . . . ,Zₘ) in accordance with the predetermined direction. Each of the blocks includes a plurality of gate lines and a plurality of touch electrodes 121. The number of the gate lines within one block is larger than the number of the touch electrodes 121 within the same block. The consecutive gate driving operations and the touch driving operations are performed within different blocks. In addition, within each frame, the touch driver 122 performs the touch driving operations toward the same touch electrode 121 at least twice.

For example, the display panel with a resolution of 960*540 includes n number of gate lines where n equals to 960. The display panel may be divided along the extending direction of the data line into m number of blocks where m equals to 20. Each of the blocks includes 48 gate lines. If the touch driver 122 performs the touch driving operations toward the same touch electrode 121 twice during each frame, the gate driving operations would not be applied toward the block (Z₁). When the touch driving operations are performed within the block (Z₂), the consecutive gate driving operations are performed within an upper portion of the block (Z₁). When the touch driving operations are performed within the block (Z₃), the consecutive gate driving operations are performed within a lower portion of the block (Z₁). When the touch driving operations are performed within the block (Z₂₀), the consecutive gate driving operations have not yet reached the block (Z₂₀). That is, the gate driving signals are not overlapped with the touch signals.

In an example, the number of the gate lines within one block is as twice as many as the number of the touch electrodes 121. When the display panel is divided into 20 blocks, each of the blocks includes 48 gate lines. In addition, 24 touch electrodes 121 are configured to drive each of the blocks. The driving frequency of the touch electrodes 121 is higher than the driving frequency of the gate line for normal display operations. The touch driver 122 performs the touch driving operations toward the touch electrodes 121 within the first block (Z₁) and the last block (Zₘ) during the second time gap (t₂). In addition, the touch driver 122 performs the touch driving operations toward the touch electrodes 121 within other blocks during the first time gap (t₁). As such, within each frame, the touch driver 122 performs the touch driving operations toward one touch electrodes 121 twice.

It can be understood that the touch driver 122 may configured to perform the touch driving operation during each first time gap (t₁) once and to perform the touch driving operations for a specific number of times during each second time gap (t₂) in accordance with the number of the gate lines and the number of the touch electrodes 121 within each block.

According to the present disclosure, the display panel may further include a common electrode, which may be arranged on a color film substrate. Correspondingly, the display component 11 is arranged on the array substrate of the display panel. The display component 11 and the touch component 12 may share the common electrode. The display component 11 is configured to perform the touch driving operations within the first time gap (t₁) and the second time gap (t₂) when the voltage of the common electrode is in a stable state

During the displaying state, the gate driver 111 outputs the gate driving signals at high level, and controls the gate lines to output signals at high level. In addition, the gate driver 111 turns on the TFT (T). The data driver 112 outputs the grayscale driving signals at high level to charge the pixel areas 113 so as to display the images.

During the touch state, the touch driver 122 applies driving signals toward the touch electrodes 121. In addition, the touch driver 122 obtains the detection signals from the common electrode so as to perform the detection for the capacitance change between the common electrode and the touch electrodes 121 caused by the touch event.

In the embodiment, the gate driving signals and the grayscale driving signals during the displaying state are overlapped with the duration for which the touch signals are applied during the touch state. As such, the touch detection may be driven by high frequency, and the sampling duration of the touch detection is longer.

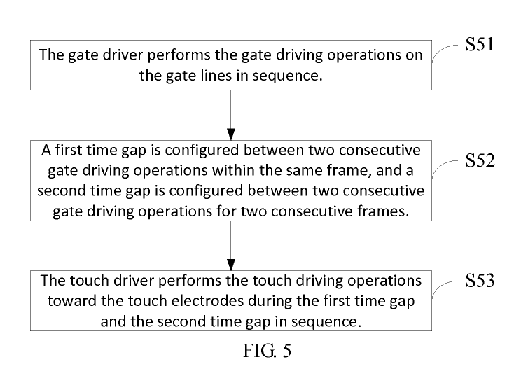

FIG. 5 is a flowchart of the touch detection method for detecting the touch on the display panel of FIG. 1 in accordance with one embodiment. The method includes the following steps.

In step S51, the gate driver performs the gate driving operations on the gate lines in sequence.

In step S52, a first time gap (t₁) is configured between two consecutive gate driving operations within the same frame, and a second time gap (t₂) is configured between two consecutive gate driving operations for two consecutive frames.

In step S53, the touch driver performs the touch driving operations toward the touch electrodes during the first time gap (t₁) and the second time gap (t₂) in sequence.

The touch detection method may be performed by the above-mentioned components of the display panel. The detail steps of the touch detection method may be referenced to the operations during the display state and the touch state of the display panel.

In view of the above, a first time gap (t₁) is configured between two consecutive gate driving operations within the same frame, and a second time gap (t₂) is configured between two consecutive gate driving operations for two consecutive frames. The touch driver performs the touch driving operations toward the touch electrodes during the first time gap (t₁) and the second time gap (t₂) such that the display signals and the touch signals are not overlapped with each other. In this way, the display signals and the touch signals are prevented from being interfered by each other so as to enhance the touch and the display performance.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A display panel having touch function, comprising:
a display component, a touch component, and a common electrode, the display component and the touch component share the common electrode, the display component comprises a plurality of gate lines arranged along a predetermined direction and a gate driver for driving the gate lines, the gate lines being spaced apart from each other, the touch component comprises a plurality of touch electrodes arranged along the predetermined direction and a touch driver for driving the touch electrodes, and the touch electrodes are spaced apart from each other, the gate driver is configured for performing gate driving operations for the gate lines in sequence, a first time gap is configured between two consecutive gate driving operations within one frame, a second time gap is configured between two consecutive gate driving operations for two consecutive frames, the touch driver being configured for performing the touch driving operations toward the touch electrodes during the first time gap and the second time gap in sequence, the display component is configured for performing touch driving operations within the first time gap and the second time gap when a voltage of the common electrode is in a stable state; and
the display panel is divided into a plurality of blocks along the predetermined direction, each of the blocks comprises a plurality of gate lines and a plurality of touch electrodes, a number of the gate lines within one block is larger than the number of the touch electrodes within the same block, the consecutive gate driving operations and the touch driving operations are performed within different blocks, within each frame, the touch driver is configured for performing the touch driving operations toward the same touch electrode at least twice.

2. The display panel as claimed in claim 1, wherein the number of the gate lines within one block is as twice as many as the number of the touch electrodes, the touch driver is configured for performing the touch driving operations toward the touch electrodes within a first block and a last block during the second time gap, and the touch driver is configured for performing the touch driving operations toward the touch electrodes within other blocks during the first time gap such that the touch driver is configured for performing the touch driving operations toward one touch electrodes twice.

3. The display panel as claimed in claim 1, wherein the display component further comprises:
a plurality of data lines intersecting with the gate lines and a data driver for driving the data lines, the data lines are spaced apart from each other, and the data lines and the gate lines are insulated from each other, the gate lines and the data lines cooperatively define a plurality of pixel areas in a matrix;
TFTs and pixel electrodes arranged within each of the pixel areas, a gate of the TFT being connect to the corresponding gate line, a source of the TFT being connected to the corresponding data line, a drain of the TFT being connected to the pixel electrode, and the data driver is configured for performing grayscale driving operations toward the data lines when the gate driver performs the gate driving operations.

4. A display panel having touch function, comprising:
a display component and a touch component, the display component comprises a plurality of gate lines arranged along a predetermined direction and a gate driver for driving the gate lines, the gate lines being spaced apart from each other, the touch component comprises a plurality of touch electrodes arranged along the predetermined direction and a touch driver for driving the touch electrodes, and the touch electrodes are spaced apart from each other, the gate driver is configured for performing gate driving operations for the gate lines in sequence, a first time gap is configured between two consecutive gate driving operations within one frame, a second time gap is configured between two consecutive gate driving operations for two consecutive frames, and the touch driver is configured for performing the touch driving operations toward the touch electrodes during the first time gap and the second time gap in sequence.

5. The display panel as claimed in claim 4, wherein the display panel is divided into a plurality of blocks along the predetermined direction, each of the blocks comprises a plurality of gate lines and a plurality of touch electrodes, a number of the gate lines within one block is larger than the number of the touch electrodes within the same block, the consecutive gate driving operations and the touch driving operations are performed within different blocks, within each frame, the touch driver is configured for performing the touch driving operations toward the same touch electrode at least twice.

6. The display panel as claimed in claim 5, wherein the number of the gate lines within one block is as twice as many as the number of the touch electrodes, the touch driver is configured for performing the touch driving operations toward the touch electrodes within a first block and a last block during the second time gap, and the touch driver is configured for performing the touch driving operations toward the touch electrodes within other blocks during the first time gap such that the touch driver is configured for performing the touch driving operations toward one touch electrodes twice.

7. The display panel as claimed in claim 4, wherein the display component further comprises:
a plurality of data lines intersecting with the gate lines and a data driver for driving the data lines, the data lines are spaced apart from each other, and the data lines and the gate lines are insulated from each other, the gate lines and the data lines cooperatively define a plurality of pixel areas in a matrix;
TFTs and pixel electrodes arranged within each of the pixel areas, a gate of the TFT being connect to the corresponding gate line, a source of the TFT being connected to the corresponding data line, a drain of the TFT being connected to the pixel electrode, and the data driver is configured for performing grayscale driving operations toward the data lines when the gate driver performs the gate driving operations.

8. The display panel as claimed in claim 4, wherein the display panel further comprises a common electrode, the display component and the touch component share the common electrode, and the display component is configured for performing the touch driving operations within the first time gap and the second time gap when a voltage of the common electrode is in a stable state

9. A touch detection method for a display panel, the display panel comprises a display component and a touch component, the display panel comprises a plurality of gate lines arranged along a predetermined direction and a gate driver for driving the gate lines, the gate lines being spaced apart from each other, the touch component comprises a plurality of touch electrodes arranged along the predetermined direction and a touch driver for driving the touch electrodes, the method comprising:
performing gate driving operations on the gate lines in sequence by the gate driver;
configuring a first time gap between two consecutive gate driving operations within the same frame and configuring a second time gap between two consecutive gate driving operations for two consecutive frames; and
performing the touch driving operations toward the touch electrodes during the first time gap and the second time gap by the touch driver.

10. The touch detection method as claimed in claim 9, wherein the display panel is divided into a plurality of blocks along the predetermined direction, each of the blocks comprises a plurality of gate lines and a plurality of touch electrodes, a number of the gate lines within one block is larger than the number of the touch electrodes within the same block, the consecutive gate driving operations and the touch driving operations are performed within different blocks, within each frame, the touch driver is configured for performing the touch driving operations toward the same touch electrode at least twice.

11. The touch detection method as claimed in claim 10, wherein the number of the gate lines within one block is as twice as many as the number of the touch electrodes, the touch driver is configured for performing the touch driving operations toward the touch electrodes within a first block and a last block during the second time gap, and the touch driver is configured for performing the touch driving operations toward the touch electrodes within other blocks during the first time gap such that the touch driver is configured for performing the touch driving operations toward one touch electrodes twice.

12. The touch detection method as claimed in claim 9, wherein the display component further comprises: a plurality of data lines intersecting with the gate lines and a data driver for driving the data lines, the data lines are spaced apart from each other, and the data lines and the gate lines are insulated from each other, the gate lines and the data lines cooperatively define a plurality of pixel areas in a matrix; and
TFTs and pixel electrodes arranged within each of the pixel areas, a gate of the TFT being connect to the corresponding gate line, a source of the TFT being connected to the corresponding data line, a drain of the TFT being connected to the pixel electrode, and the data driver is configured for performing grayscale driving operations toward the data lines when the gate driver performs the gate driving operations.

13. The touch detection method as claimed in claim 9, wherein the display panel further comprises a common electrode, the display component and the touch component share the common electrode, and the display component is configured for performing the touch driving operations within the first time gap and the second time gap when a voltage of the common electrode is in a stable state.
